(19) United States
(12) Patent Application Publication
(10) Pub. No.: US 2016/0123375 A1
(43) Pub. Date: May 5, 2016

(54) Drive-Cable Liner

(71) Applicant: Thomas Edgman, Farmers Branch, TX (US)

(72) Inventor: Thomas Edgman, Farmers Branch, TX (US)

(21) Appl. No.: 14/924,937

(22) Filed: Oct. 28, 2015

Related U.S. Application Data
(60) Provisional application No. 62/073,118, filed on Oct. 31, 2014.

(51) Int. Cl. F16C 1/26; A01D 34/82; A01D 34/76; F16C 1/06

(52) U.S. Cl. CPC F16C 1/26; F16C 1/06; A01D 34/822; A01D 34/76

(57) ABSTRACT

A drive-cable liner is provided for centering a drive cable of a motorized tool, such as a weed trimmer. The liner comprises a hollow tube capable of circumferentially securing the drive cable. Annular elements are integrally formed along the exterior surface of the hollow tube, preferably using a corrugation process. Annular elements are longitudinally spaced along the hollow tube and have an exterior surface that urges against the interior of a shaft of the tool. The drive cable is thereby centered within the shaft.

### TECHNICAL FIELD

The present invention relates generally to drive-cable liners and, more particularly, to a liner for use in centering a drive cable for a weed trimmer or other drive-cable tools.

### BACKGROUND

Drive cables are used by motorized tools, such as weed trimmers, in order to transfer power from a tool's motor to a working part. For example, the drive cable in a weed trimmer transfers power from the motor, down a shaft, and to a cutting tool, which is then caused to rotate. A drive-cable liner is typically used to center the drive cable within the shaft.

Conventional liners are typically formed from a hollow plastic tube having fins extending radially outward along the entire length of the liner. A disadvantage of such liners is that they must meet stringent manufacturing tolerances. On one hand, if the liner is too thin, the drive cable may not remain centered and thus cause vibrations and wear. On the other hand, if the liner is too wide, the liner may not be able to be inserted into the shaft or the fins may buckle thus resulting in the drive cable being off center. Meeting such stringent manufacturing tolerances is expensive and also results in many liners being rejected during the manufacturing process. Typically, such liners require trimming of the outside diameter resulting in wasted raw materials and additional labor costs. Another disadvantage of such liners is that the fins require a lot of material to form and thus further increasing manufacture costs.

Other conventional liners use rubber spacers fitted around a hollow tube. A disadvantage of such liners is that the rubber spacers must be individually fitted onto the hollow tube, which is a labor intensive process. Another disadvantage is that the rubber spacers are difficult to longitudinally align along the hollow tube. And, even when aligned properly, the rubber spacers may move or slide during use. This may result in the drive cable moving off center, thus leading to excessive wear and premature failure.

Many variations to the above described conventional liners exist. Yet they also suffer from many of the same disadvantages.

Accordingly, there is a need for a liner that can be efficiently and cost-effectively manufactured.

### SUMMARY

The present invention provides a liner for use in centering a drive cable. The liner comprises a hollow tube. A plurality of longitudinally-spaced, annular elements is integrally formed along the hollow tube. In another embodiment, the annular elements are circumferential corrugations. In another embodiment, the outside surfaces of the annular elements are convex. In still another embodiment, the outside surfaces of the annular elements are concave.

In another embodiment, a weed trimmer is provided. A drive unit for providing torque is coupled to a hollow shaft. A cutting unit having a rotatable-cutting member is coupled to the shaft. A liner is disposed concentrically inside the shaft. The liner comprises a hollow tube. A plurality of annular elements is integrally formed along the hollow tube. The outside surface of each of the annular elements urges against the inside surface of the shaft. A drive cable is disposed concentrically inside the hollow tube of the liner. The drive cable is coupled to the drive unit at one end and the rotatable-cutting member at the other end.

In yet another embodiment, a method of manufacturing a liner for centering a drive cable is provided. A hollow cylindrical plastic tube is extruded. A plurality of longitudinally-spaced, annular elements is then formed along the exterior surface of the tube. In another embodiment, the annular elements are formed using a corrugation process.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a liner in accordance with a preferred embodiment of the present invention exemplified in a weed trimmer;

FIG. 2 is an isometric view of a liner in accordance with principles of the present invention;

FIGS. 3A and 3B are cross-sectional views of a first embodiment of an annular element of the liner shown in FIG. 2 taken along section line A-A in accordance with principles of the present invention;

FIGS. 4A and 4B are cross-sectional views of a second embodiment of an annular element of the liner shown in FIG. 2 taken along section line A-A in accordance with principles of the present invention; and

FIGS. 5A and 5B are cross-sectional views of a third embodiment of an annular element of the liner shown in FIG. 2 taken along section line A-A in accordance with principles of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

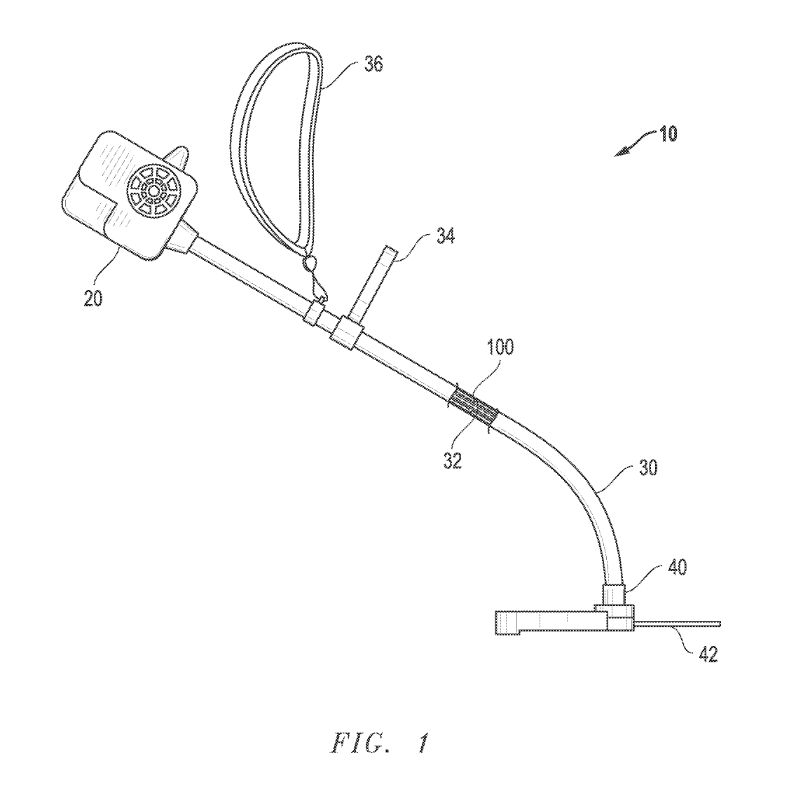

Referring to FIG. 1, liner 100 is shown being exemplified in weed trimmer 10. While the present invention is exemplified for use in a weed trimmer, it may also be used for other applications requiring centering of a rotating drive cable (or shaft). Drive unit 20 is coupled to shaft 30. Drive unit 20 may be a gas powered motor or an electrical motor. Shaft 30 is generally tubular having a hollow interior. Shaft 30 may be curved as shown, but need not be. Handle 34 and strap 36 are affixed to shaft 30. Handle 34 and strap 36 allow an operator to handle and maneuver trimmer 10 to perform trimming operations. Cutting unit 40 having rotatable-cutting member 42 is coupled to the opposite end of shaft 30 from drive unit 20.

Liner 100 is positioned in the hollow interior of shaft 30 and has a hollow interior extending along the axial center of shaft 30. Drive cable 32 is positioned generally along the axial center of the hollow interior of liner 100 and extends along the axial center of shaft 30. Liner 100 and drive cable 32 are preferably flexible allowing them to be used in a curved shaft, but need not be. Drive cable 32 is coupled to drive unit 20 at one end and to rotatable-cutting member 42 at the other end. Drive unit 20 may apply torque to drive cable 32, which is transferred to rotatable-cutting member 42. Rotatable-cutting member 42 may thereby be rotated and used to cut or trim grass, vegetation, etc.

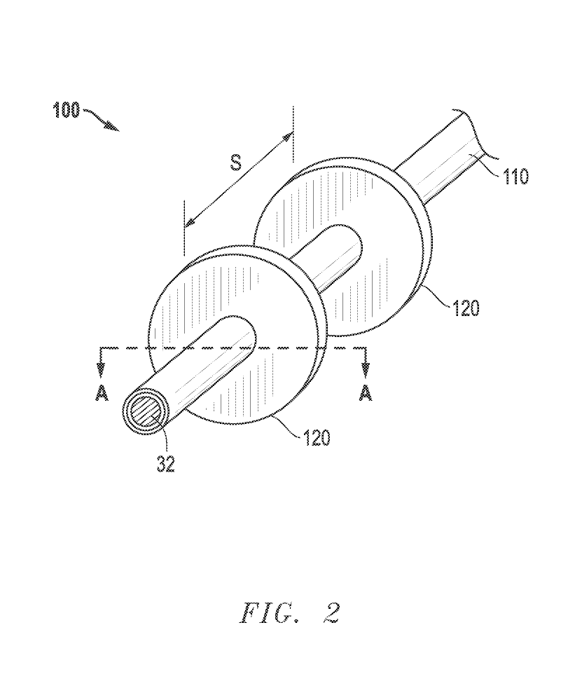

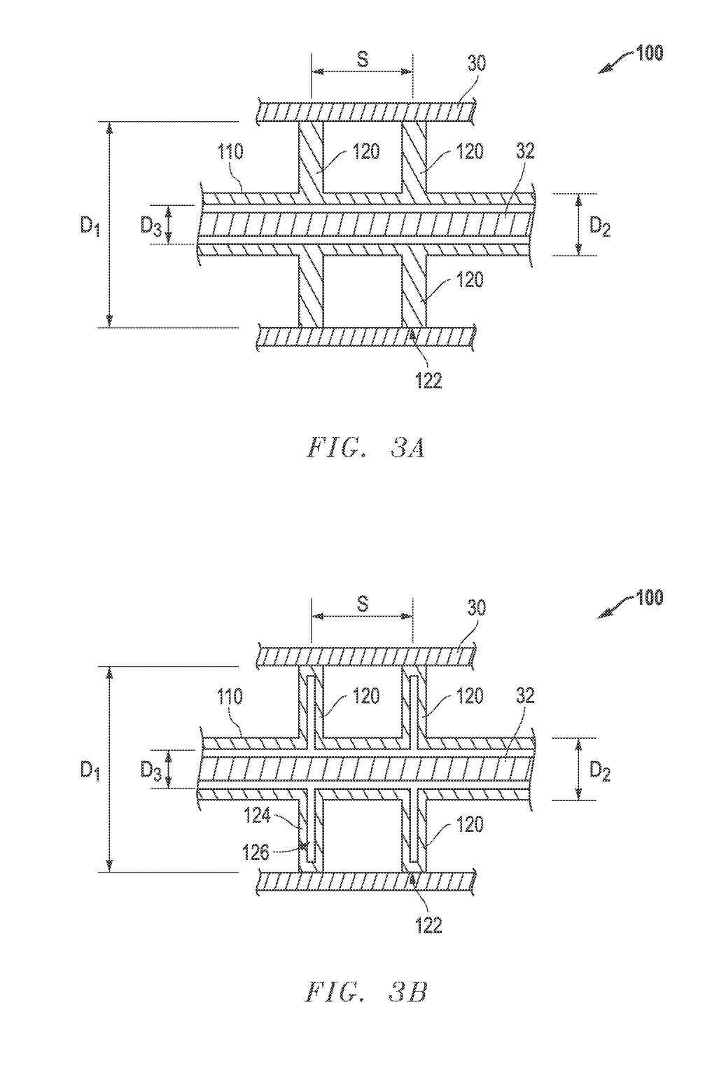

Referring to FIG. 2, a first embodiment of liner 100 is shown exemplified centering drive cable 32. Liner 100 comprises hollow tube 110. A plurality of annular elements 120 are integrally formed along the exterior surface of hollow tube 110. Annular elements 120 are formed with the hollow tube 110 from a single, unitary piece of material. This ensures that annular elements 120 maintain their longitudinal positioning when liner 100 is mounted into shaft 30 (see FIG. 1). Preferably, annular elements 120 are manufactured using a corrugation process, wherein each annular element 120 comprises a circumferential corrugation (see FIGS. 3B, 4B, and 5B). Alternatively, annular elements 120 may be made using injection molding or other means (see FIGS. 3A, 4A, and 5A). Annular elements are longitudinally spaced apart by a distance S (see FIG. 2). Distance S is preferably between about 2 and 6 inches. In certain embodiments, the spacing is uniform, but need not be. Preferably, a narrower spacing is used in critical areas, such as where shaft 30 curves, thus ensuring that drive cable 32 stays centered. By way of example, but not limitation, in one preferred embodiment, distance S is about 6 inches in straight portions of shaft 30 and about 2 inches in curved portions of shaft 30. Preferably, liner 100 is between about 10 inches and about 70 inches in overall length, more preferably about 52 inches in length. Preferably, liner 100 is made from Nylon 66.

As best shown in FIGS. 3A and 3B, annular elements 120 have outside diameter D₁. Outside diameter D₁ is selected to correspond to the inside diameter of a shaft in which liner 100 is to be inserted. Outside surface 122 of annular elements 120 thereby urges against the inside surface of shaft 30. By way of example, but not limitation, outside diameter D₁ is preferably between about 1 inch and about 0.75 inches. By way of example, but not limitation, in a preferred embodiment, outside diameter D₁ is about 0.902 inches. Hollow tube 110 has outside diameter D₂. By way of example, but not limitation, outside diameter D₂ is preferably between about 0.25 inches and about 0.35 inches. By way of example, but not limitation, in a preferred embodiment, outside diameter D₂ is about 0.305 inches. Hollow tube 110 has an inside diameter D₃. Inside diameter D₃ is selected so as to be slightly larger than the outside diameter of a drive cable (32) with which liner 100 is to be used. By way of example, but not limitation, inside diameter D₃ is preferably between about 0.15 inches and about 0.25 inches. By way of example, but not limitation, in a preferred embodiment, inside diameter D₃ is about 0.205 inches. Advantageously, the ratio between D₁ to D₂ is preferably maximized in order to conserve material. Preferably, the ratio D₁D₂ is greater than or equal to 2. In the preferred embodiment, the ratio D₁:D₂ is about 3. When liner 100 is manufactured using a corrugation process, annular elements 120 comprise circumferential corrugations 124 and annular channels 126 as shown in FIGS. 3B.

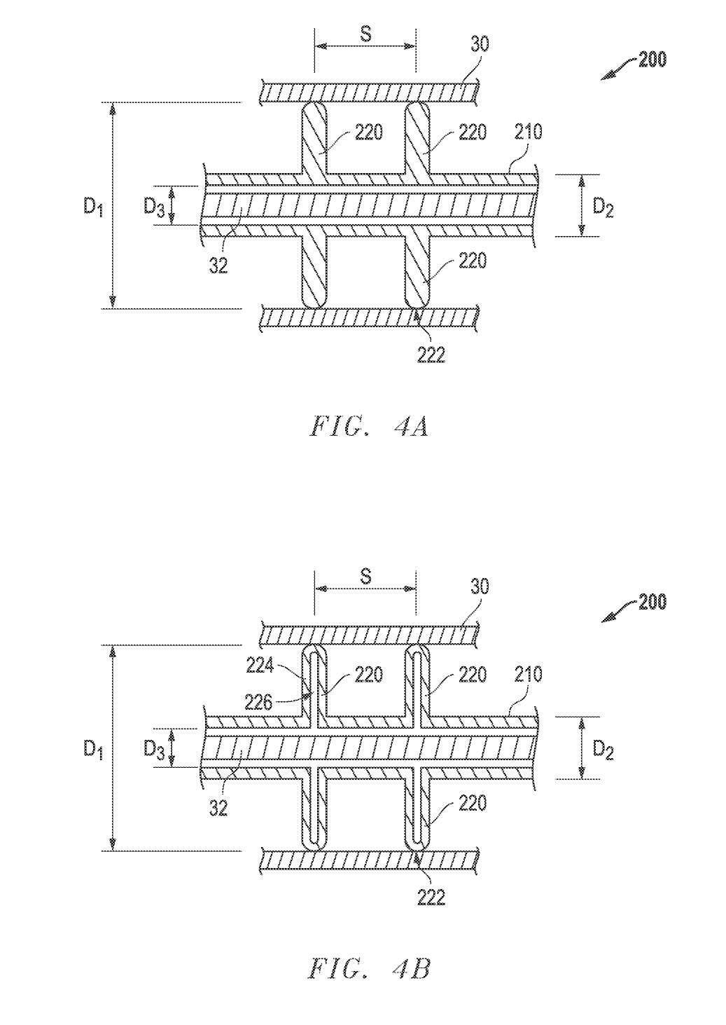

Referring to FIGS. 4A and 4B, in accordance with a second embodiment, liner 200 is shown exemplified centering drive cable 32. Liner 200 comprises hollow tube 210 and annular elements 220. Annular elements 220 have convex outside surfaces 222 as shown. Convex outside surfaces 222 advantageously provide for easier installation into shaft 30, even when outside D₁ exceeds the inside diameter of shaft 30. Thus, it allows for less stringent manufacturing tolerances to be employed. It is further advantageous as it requires less material to form annular elements 220. When liner 200 is manufactured using a corrugation process, annular elements 220 comprise circumferential corrugations 224 and annular channels 226 as shown in FIGS. 4B. In all other respects, liner 200 is similar to liner 100 shown in FIGS. 1-3.

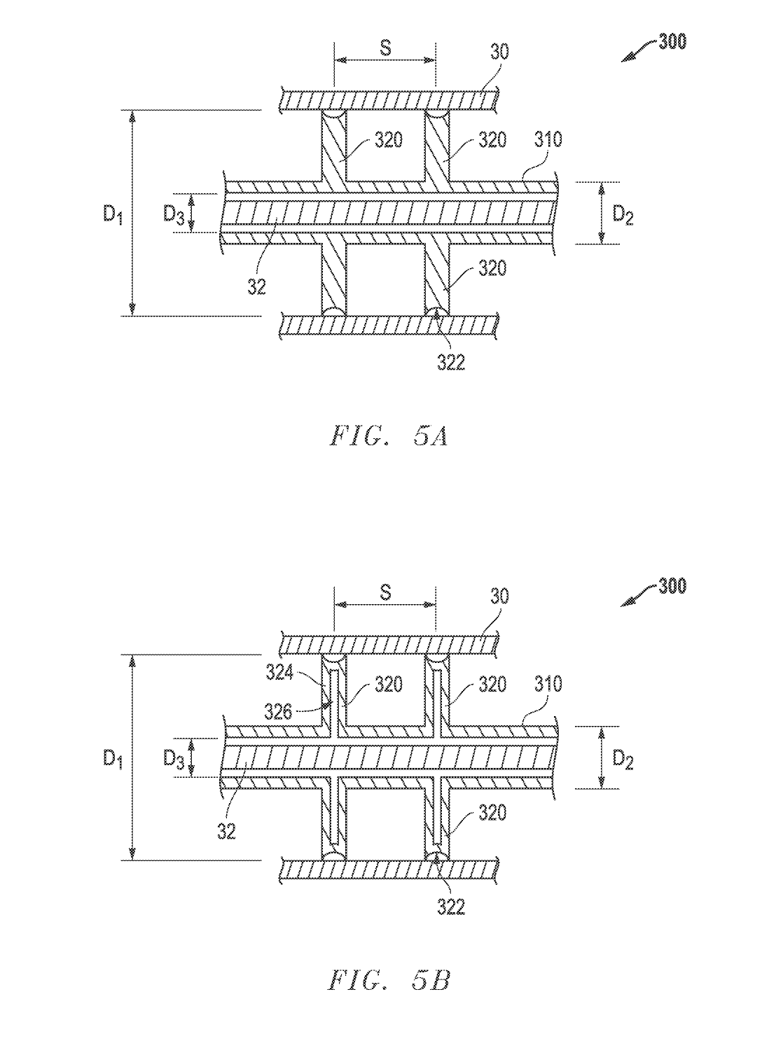

Referring to FIGS. 5A and 5B, in accordance with a third embodiment, liner 300 is shown exemplified centering drive cable 32. Liner 300 comprises hollow tube 310 and annular elements 320. Annular elements 320 have concave outside surfaces 322 as shown. Concave outside surfaces 322 advantageously provide for easier installation into shaft 30, even when outside diameter D₁ exceeds the inside diameter of shaft 30. Thus, it allows for less stringent manufacturing tolerances to be employed. It is further advantageous as it requires less material to form annular elements 320. When liner 300 is manufactured using a corrugation process, annular elements 320 comprise circumferential corrugations 324 and annular channels 326 as shown in FIGS. 5B. In all other respects, liner 300 is similar to liner 100 shown in FIGS. 1-3.

It is understood that the present invention may take many forms and embodiments. Accordingly, several variations may be made in the foregoing without departing from the spirit or the scope of the invention. For example, the liner could be a composite liner, wherein liner 100, 200, or 300 is positioned concentrically around an inner sheath and the drive shaft is positioned concentrically within the inner sheath.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A liner for use in centering a drive cable, the liner comprising:
a hollow tube; and
a plurality of longitudinally-spaced, annular elements integrally formed along the hollow tube.

2. The liner of claim 1, wherein the annular elements and the hollow tube are formed from a single unitary piece of plastic.

3. The liner of claim 1, wherein the annular elements comprise circumferential corrugations formed along the exterior surface of the tube.

4. The liner of claim 1, wherein the longitudinal spacing between each of the annular elements is uniform.

5. The liner of claim 1, wherein the longitudinal spacing between each of the annular elements is non-uniform.

6. The liner of claim 1, wherein each of the annular elements is longitudinally spaced between 2 inches to 6 inches apart from one another.

7. The liner of claim 1, wherein each of the annular elements is longitudinally spaced about 4 inches apart from one another.

8. The liner of claim 1, wherein each of the annular elements has an outside diameter between about 0.75 inches to about 1 inch.

9. The liner of claim 1, wherein each of the annular elements has an outside diameter of about 0.902 inches.

10. The liner of claim 1, wherein the hollow tube has an outside diameter between about 0.25 inches to about 0.35 inches.

11. The liner of claim 1, wherein the hollow tube has an outside diameter of about 0.305 inches.

12. The liner of claim 1, wherein the hollow tube has an inside diameter between about 0.15 inches to about 0.25 inches apart.

13. The liner of claim 1, wherein the hollow tube has an inside diameter of about 0.205 inches.

14. The liner of claim 1, wherein the liner is between about 10 inches and about 70 inches in length.

15. The liner of claim 1, wherein the liner is about 52 inches in length.

16. The liner of claim 1, wherein the ratio of the outside diameter of the annular elements to the outside diameter of the hollow tube is greater than or equal to 2.

17. The liner of claim 1, wherein the ratio of the outside diameter of the annular elements to the outside diameter of the hollow tube is equal to about 3.

18. A method of manufacturing a liner for centering a drive cable comprising steps of:
extruding a hollow cylindrical plastic tube; and
forming a plurality of longitudinally-spaced, annular elements along the exterior surface of the tube.

19. The method of claim 18, wherein the step of forming comprises a corrugation process.

20. An apparatus formed by the process of claim 18.

21. A weed trimmer comprising:
a drive unit;
a hollow shaft coupled to the drive unit;
a cutting unit coupled to the shaft having a rotatable-cutting member;
a drive cable disposed concentrically inside the shaft and coupled to the drive unit at one end and the rotatable-cutting member at the other end; and
a liner disposed concentrically inside the shaft and circumferentially around the drive cable, the liner comprising:
a hollow tube; and
a plurality of longitudinally-spaced, annular elements integrally formed along the hollow tube, wherein the outside surface of each of the annular elements urges against the inside surface of the shaft.
